(19) United States
(12) Patent Application Publication
(10) Pub. No.: US 2026/0236478 A1
(43) Pub. Date: Aug. 13, 2026

(54) METHODS AND SYSTEMS FOR PROVIDING RECOMMENDATIONS

(71) Applicant: SHOPEE IP SINGAPORE PRIVATE LIMITED, Singapore (SG)

(72) Inventor: Wanyao ZHANG, Singapore (SG)

(21) Appl. No.: 19/535,114

(22) Filed: Feb. 10, 2026

(30) Foreign Application Priority Data
Feb. 10, 2025 (SG) 10202500362U

(51) Int. Cl. G06F 16/2457

(52) U.S. Cl. CPC G06F 16/24578

(57) ABSTRACT

Provided herein are systems, methods, and computer-readable media for providing recommendations based on user queries and trend analysis. An example method includes receiving a query at a first platform from a user; conducting a trend analysis based on the query by analyzing content associated with a second platform; identifying one or more trending items based on the trend analysis; generating one or more recommendations associated with the first platform based on the identified trending items; and providing the one or more recommendations to the user via the first platform.

### CROSS-REFERENCE TO RELATED APPLICATIONS

This patent application claims the benefit of and priority to Singaporean Patent Application No. 10202500362U, filed with the Intellectual Property Office of Singapore on 10 February 2025 and titled “METHODS AND SYSTEMS FOR PROVIDING RECOMMENDATIONS,” the contents of which are incorporated by reference in its entirety for all purposes.

### TECHNICAL FIELD

The present invention generally relates to methods and systems for recommendations and, more particularly, relates to methods and systems for recommendations based on a user query with a trend analysis.

### BACKGROUND

With an increasing complexity of online shopping platforms and the abundance of available products, consumers often struggle to find items that align with their preferences or interests. Traditional search engines require users to describe their desired items in specific terms, which can be challenging when users are unable to accurately articulate the characteristics or qualities of the products they seek. Additionally, there may be a mismatch between the terms or descriptions used for a specific item between consumers and merchants for an item, or between different merchants for the same item. Since users may find it difficult to express descriptions of their desired products through precise wording, it becomes challenging to locate similar or related items effectively, diminishing the efficacy of the online shopping experience.

Currently, social media platforms like TikTok, YouTube, Twitter (now X), and Instagram have gained significant popularity among the general population and played a substantial role in influencing consumer purchasing behavior. However, while social media platforms are known to provide information about consumer trends, these social media platforms do not provide actionable insight into trending products usable by consumers to make purchasing decisions. Products that appear in social media content are typically unidentifiable unless a user posting content on the platform specifically selects and markets the consumer item in the videos. Even in such cases where an item is specifically marketed, social media platforms typically incentivise users to link to affiliated or captive online shopping platforms. Additionally, it is common on social media platforms to provide different users with different experiences based on each users’ individual network of contacts or traits, which may lead any individual’s social media to reflect an inaccurate or incomplete picture of which consumer items are trending in the population as a whole. As a result, traditional systems miss the opportunity to leverage real-time social media insights to deliver relevant, trend-based recommendations on e-commerce platforms.

There is, therefore, a need to develop an improved method for online shopping that can address these limitations by integrating real-time social media insights and trend analysis. Such a method could provide consumers with recommendations aligned with current market trends, enabling them to discover products of interest more easily and efficiently. Such a method could also infer based on a consumer’s incomplete or inaccurate description of a consumer item, the most likely item based on items known to be trending in the population as a whole.

Furthermore, other desirable features and characteristics will become apparent from the subsequent detailed description and the appended claims, taken in conjunction with the accompanying drawings and this background of the disclosure.

### SUMMARY OF THE INVENTION

In accordance with one aspect of the present invention, there is provided a method of providing recommendations, comprising: receiving a query at a first platform from a user; conducting a trend analysis based on the query; generating one or more recommendations based on the results of the trend analysis; and providing the one or more recommendations to the user via the first platform.

In some embodiments, the query is received in the form of textual input by the user.

In some embodiments, the method further comprises receiving the query from the user; analyzing the query; and classifying an intent of the query as general or specific based on the analysis; wherein if the query is determined to be a general query, the method further comprises forwarding the query to a second platform to find trending items in the second platform.

In some embodiments, the step of conducting a trend analysis based on the query further comprises sending the query to a second platform; retrieving a plurality of videos from the second platform based on the query; identifying at least one trending item from the plurality of videos; generating a plurality of products from the first platform by matching with the at least one trending item identified in the second platform; and recommending the plurality of products to the user via the first platform.

In some embodiments, the method further comprises taking screenshots at different timepoints of the plurality of videos; identifying one or more items in the screenshots using an image search model; determining similarity between the identified one or more items; selecting items with the highest similarity scores as the at least one trending item from the second platform; matching products of the first platform with the at least one trending item from the second platform; and determining a recommendation based on the matched products of the platform.

In some embodiments, the method further comprises tracking queries submitted by users over a predetermined period; identifying a plurality of search queries based on frequency of submission during the predetermined period; performing searches and retrieving video results for the identified search queries in a second platform; identifying trending items from the retrieved videos; and prestoring the plurality of search queries and the identified trending items.

In some embodiments, the method further comprises receiving the query from the user; and matching the query with the plurality of search queries; wherein if there is a match between the query and the plurality of search queries, accessing the prestored trending items of the corresponding plurality of queries; or if there is no match between the query and the plurality of queries, processing the query in real-time.

In some embodiments, the method further comprises identifying multiple trending items related to the query based on the trend analysis; and displaying the identified trending items in a balanced manner on the first platform.

In some embodiments, the query is received in the form of the user interacting with a video content.

In some embodiments, the method further comprises receiving at least one video frame from the video content; identifying one or more items using an image search model by processing the at least one video frame; matching the one or more items to identify one or more products from the first platform; creating a link for each of the one or more products; and displaying the link to the user through a user interface within the video content.

In some embodiments, the step of matching the one or more items comprises using image searches to match the one or more items to a product pool in the first platform.

In some embodiments, the step of identifying one or more items further comprises creating a search string based on the identified one or more items.

In some embodiments, the step of matching the one or more items comprises using the search string to search in the first platform.

In some embodiments, the identified one or more products is different from a product currently promoted in the video content.

In some embodiments, the step of identifying one or more items using an image search model comprises receiving an image which comprises one or more objects; identifying one or more bounding boxes around each of the one or more objects in the image using an object detection algorithm; extracting features from each of the one or more objects within the identified bounding boxes; comparing the extracted features from the image with a reference image to determine similarity; generating a similarity score that quantifies a degree of the similarity between each of the one or more objects in the image and the reference image; and determining if the similarity score of the one or more objects is above a threshold value.

In some embodiments, the step of identifying one or more objects comprises embedding the extracted features into feature vectors using an image embedding model, wherein the image embedding model converts each of the extracted feature into a high-dimensional vector representation; and comparing the feature vectors of the image and the reference image to identify the one or more objects.

In some embodiments, the method further comprises a step of fine-tuning the image embedding model using a Bidirectional Encoder Representations from Transformers (BERT) model approach for semantic understanding, wherein the BERT model is used to capture contextual relationships between the extracted features.

In accordance with another aspect of the present invention, there is provided a system for providing recommendations comprising a processor, a memory in electronic communication with the processor; and instructions stored in the memory and executable by the processor to cause the system to perform any one of the methods discussed hereinabove.

In accordance with another aspect of the present invention, there is provided an apparatus for providing recommendations comprising means for performing any one of the methods discussed hereinabove.

In accordance with another aspect of the present invention, there is provided a computer-readable storage medium, on which a computer program is stored, wherein the computer program, when executed in a computer, causes the computer to perform any one of the methods discussed hereinabove.

The embodiments described herein are not exhaustive and additional features and variations of the invention may be incorporated. Various other advantages and novel features of the invention will become apparent from the following detailed description when considered in conjunction with the accompanying drawings.

### BRIEF DESCRIPTION OF THE DRAWINGS

The disclosure will be better understood with reference to the detailed description when considered in conjunction with the non-limiting examples and the accompanying drawings, in which:

FIG. 1 is an architecture diagram of an online shopping system according to an embodiment of the invention.

FIG. 2 is a flowchart of a method for the online shopping system according to an embodiment of the invention.

FIG. 3 is an architecture diagram of the user terminal according to an embodiment of the invention.

FIG. 4 is a schematic diagram of an online shopping system using a social media platform according to an embodiment of the invention.

FIG. 5 is a flowchart of an online shopping system using a social media platform according to another embodiment of the invention.

FIG. 6 is a flowchart of an online shopping system using a social media platform to detect trending products according to another embodiment of the invention.

FIG. 7 is a flowchart of a method for online shopping with a social media platform to identify the general query according to an embodiment of the invention.

FIG. 8 is a flowchart of a method for online shopping with a social media platform with prestored trending items according to an embodiment of the invention.

FIG. 9 is a flowchart of a method for online shopping by detecting multiple items according to an embodiment of the invention.

FIG. 10 is an architecture diagram of an online live streaming shopping system for an item identification according to an embodiment of the invention.

FIG. 11 is a flowchart of a method for displaying item information for the online shopping live streaming system according to an embodiment of the invention.

FIG. 12a is a schematic diagram of a live streaming interface according to an embodiment of the invention.

FIG. 12b is a schematic diagram of an online live streaming interface to identify items in the image according to an embodiment of the invention.

FIG. 12c is a schematic diagram of an online live streaming interface with identified products according to an embodiment of the invention.

FIG. 13 is a flowchart of a method for item identification according to another embodiment of the invention.

FIG. 14a is a flowchart of a method of image processing for detecting items according to an embodiment of the invention.

FIG. 14b is a flowchart of a method of image processing for detecting items according to another embodiment of the invention.

FIG. 15 is a flowchart of a method for displaying recommended products for the online shopping system according to an embodiment of the invention.

### DETAILED DESCRIPTION

In the following detailed description, reference is made to the accompanying drawings, which form a part hereof. The illustrative embodiments described in the detailed description, drawings and claims are not meant to be limiting. Other embodiments can be utilized, and other changes can be made, without departing from the spirit or scope of the subject matter presented herein. Unless specified otherwise, the terms “comprising”, “comprise”, “including” and “include” used herein, and grammatical variants thereof, are intended to represent “open” or “inclusive” language such that they include recited elements but also permit inclusion of additional, un-recited elements.

The various embodiments are not necessarily mutually exclusive, as some embodiments can be combined with one or more other embodiments to form new embodiments. Embodiments described in the context of one of the systems or methods are analogously valid for the other systems or methods. Similarly, embodiments described in the context of a method are analogously valid for a system, an apparatus or a computer program, and vice-versa.

Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

When shopping for products, users may sometimes lack clear or specific ideas about what they are looking for. In many instances, users begin shopping with broad, generic or unclear queries, such as performing a search for “clothes for Christmas” without a clear sense of the exact items or styles they are interested in. Traditional search systems often struggle with such open-ended queries, typically producing a broad and unfocused array of results. These results can feel overwhelming or misaligned with the user’s personal preferences or current trends making the search process unnecessarily time-consuming and may lead to frustration.

Another common scenario arises when a user sees an item of interest in a video or other media, where the media is not necessarily explicitly marketing or selling the item in question. This could include in television programs, over-the-top video, online streaming or short-format videos, or other contemporary visual or audio-visual media. Identifying and searching for a specific product based on the video content can be challenging, often requiring the user to manually provide description or estimates, which may lead to incomplete or inaccurate results. Traditional methods such as reverse-image searching are insufficient due to the difficulty of capturing an image in a video stream which can be effectively compared to existing images of an item in question. In such instances, the difficulty of translating visual inspiration into a concrete search query adds to the inconvenience, diminishing the seamlessness of the shopping experience.

This lack of certainty or targeted queries often results in time-consuming searches or missed opportunities for relevant product discovery. The current invention addresses this challenge by using a second platform data to analyze and identify emerging trends that are relevant to the user’s potential interests. By analyzing user queries in the context of popular trends and other relevant social media data, the system refines the recommendations, presenting options that are not only trending but also attuned to the user’s implied preferences. For instance, if a user searches for “clothes for Christmas” without specifying a particular style, the system can narrow down options by highlighting trending seasonal styles, helping the user quickly discover trending fashion products that match their personal style. Traditional product recommendation systems are based only on information from sales consummated on a given platform, which limits their ability to provide responsive suggestions based on emerging trends. It is noted that the shopping system encompasses all forms of platforms, such as e-commerce platforms, where users can purchase products. This includes, but is not limited to, platforms such as Amazon, Taobao, Shopee, and similar online marketplaces. The shopping system can also be integrated via a simple link embedded in any video, image, or social media website, allowing users to access product listings directly from video or social media platform such as YouTube or Instagram. For example, when a user is watching a YouTube video, an embedded link to a product listing on a first platform can be provided. The user can interact with this embedded link within the YouTube video to access the product on the first platform.

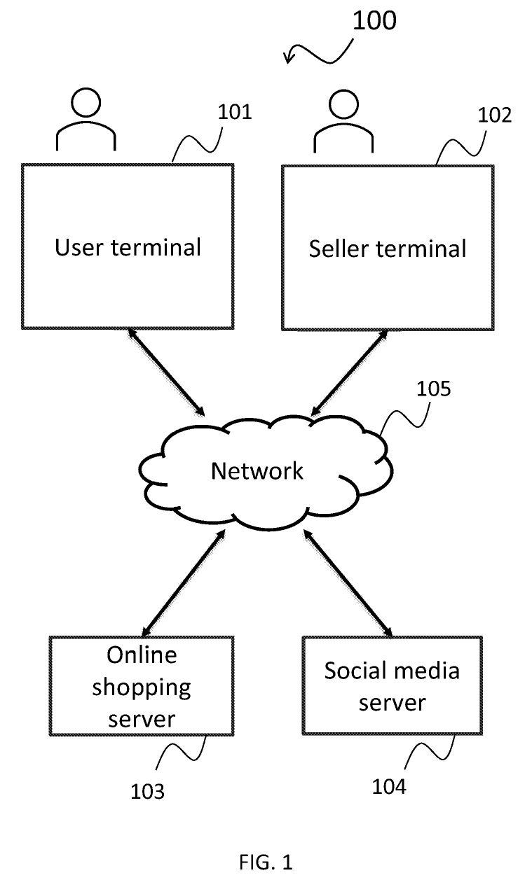

FIG. 1 is an architecture diagram of an online shopping system according to an embodiment of the invention. As shown in FIG. 1, the online shopping system 100 includes, but is not limited to, a user terminal 101, a seller terminal 102, an online shopping server 103 and a social media server 104. The user terminal 101 and the seller terminal 102 can both be referred to as user terminals. The user and seller can both be referred to as the user. These elements within the system 100 can be interconnected by a network 105.

The user terminal 101 and the seller terminal 102 can be any type of computing device capable of communicating messages over a network 105. For example, the user terminal 101 and the seller terminal 102 may be a smartphone, a tablet computer, a notebook computer, a desktop computer, or the like, but is not limited thereto. An application including a social media function can be installed and run on the user terminal 101 or the seller terminal 102. The user terminal 101, a seller terminal 102, an online shopping server 103 and a social media server 104 may be directly or indirectly connected in a wired or wireless communication manner, which is not limited in this application.

The user terminal 101 can transmit the search query or the query to the online shopping server 103. The online shopping server 103 can further transmit the search query to the social media server 104. The social media server 104 can return the top resources to the online shopping server 103. The social media platform associated with the social media server 104 can utilize different resources, like videos, images and publications. A person skilled in the art will recognize that there can be different types of social media platforms such as those branded TikTok and Instagram. The user terminal 101 can receive the recommended products returned by the online shopping server 103. Therefore, the user terminal 101 can display the products recommended based on the product’s popularity on the social media platform, allowing the user to interact through the user terminal 101 to conduct the further online shopping process.

It is noted that, although social media platform is used as an example in embodiments of the present invention, other platforms capable of identifying trending items may also be used without departing from the scope of the invention. For instance, platforms specifically designed for trending item analysis are also within the scope of this invention.

It is noted that the search query or query can take various formats. In some embodiments, the query is received through user interactions with the video content. For example, in a live streaming context, the user may watch the live streaming or click on certain items featured in the live streaming. In other embodiments, the query is received in the form of textual input by the user, or a combination of the above.

The user terminal 101 and the seller terminal 102 represent examples of the types of terminals involved. However, this is just one possible scenario. A person skilled in the art will recognize that the number of terminals can vary widely; there could be just one terminal, or there might be dozens, hundreds, or even more. The specifics of the quantity and types of devices used are not limited by this embodiment of the application.

The online shopping server 103 and the social media server 104 can take various forms, including a standalone physical server, a cluster of servers, or a cloud-based solution. As a cloud server, it might offer a range of cloud computing services such as cloud storage, databases, computing power, network services, middleware, domain name services, security features, content delivery networks (CDNs), big data analytics, and artificial intelligence capabilities.

In some embodiments of the invention, the number of servers involved can vary; there may be a single server or multiple servers depending on the application's needs. Additionally, the servers might include other specialized servers to offer a broader range of services, enhancing the overall functionality of the system.

The network 105 can include a combination of a local area network (LAN), a wide area network (WAN), a land network, a wireless network, a data bus, telephone network, a point-to-point network, a satellite network, a token ring network, and/or a hub network.

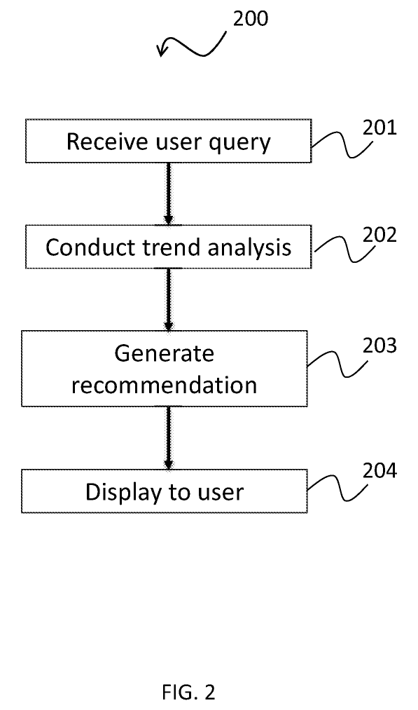

FIG. 2 is a flowchart of a method for the online shopping system according to an embodiment of the invention.

The different methods disclosed herein are not necessarily limiting. Steps can be added, omitted, and/or performed simultaneously without departing from the scope of the appended claims. The methods may include any number of additional or alternative tasks and that the method may be incorporated into a more comprehensive procedure or process having additional functionality not described in detail herein. Moreover, one or more of the tasks could be omitted from an embodiment of the method as long as the intended overall functionality remains intact. The illustrated method can also be stopped at any time. The method is computer-implemented in that various tasks or steps that are performed in connection with the method may be performed by software, hardware, firmware, or any combination thereof.

In some embodiments, before the user can use the online shopping system, the user needs to be authenticated by the system. The user authentication through login is to ensure a secure and personalized experience. Before accessing the system's features, users are required to log in with their credentials, such as a username and password. This process verifies their identity and protects sensitive information, including personal details and payment methods. Authentication also allows the system to provide a tailored shopping experience by remembering user preferences and past purchases.

Referring to FIG. 2, with the method being performed by a user terminal as an example, the method includes the following steps:

At step 201, the method begins when a user submits a query to a first platform. The query may include specific keywords related to products, product categories, or other identifying features. The query may also be a broad or generic query, such as “dress”. The first platform may take various forms, such as an e-commerce platform or any other platform capable of recommending products to users.

At step 202, once the query is received, the method processes the query by conducting a trend analysis. The trend analysis may be performed by sending the query to a second platform, such as a social media platform, an e-commerce platform or any platform which can provide the trend information, to analyze relevant trends. Trend analysis including social media platform data may consider, but is not limited to, the amount of content provided to or published on the social media platform that references or includes a given product, textual descriptions attached to social media content by the originator of said content or other users of the social media platform, the level of engagement among users of the social media platform with specific items of content, or the presence or absence of specific content among users based on their popularity or degree of activity on the social media platform. In some embodiments, the trend analysis considers not only the social media trends but can also include data such as historical data about the user, the product sales data, and products reviews. In other embodiments, the trend analysis may give different weightings based on the metadata applicable to content on the platform, which, by way of example only, can include providing additional weight to less-prolific users of the platform, and reduced weighting to users involved in traditional marketing activities such as paid influencers, or product reviewers. In yet other embodiments, the trend analysis may assign weights in different ways.

At step 203, the method generates the recommendation. By incorporating the identified trending factors and/or products, the method can determine which products among those available on the first platform are the most likely to correspond to the trending products, and by extension to be responsive to the user query. In the alternative, the method can determine which multimedia contents among those available on the first platform are most likely to correspond to the query, and thereby provide multimedia contents that will facilitate the user to identify products responsive to the query. The multimedia contents can include images, videos or live streaming, which further enhances the recommendation by offering dynamic content.

At step 204, the recommended product is displayed to the user via the first platform, such as the e-commerce platform.

In some embodiments, by monitoring and aggregating data from various social media platforms, the method identifies trending products more accurately. These trends are then analyzed in real time and correlated with the user's general preferences or past behaviors, enabling the system to provide highly relevant product recommendations even when the user’s query is general or broad. This approach ensures that users are presented with products that are most likely to align with emerging or existing trends among a relevant population, enhancing the overall shopping experience.

In some embodiments, the invention also relates to a system and method for automatically recommending products to users based on image/video content in the social media platform, e-commerce platform or any platform which can provide the trend information. The system analyzes text, image or video data in the social media platform, e-commerce platform or any platform which can provide the trend information to identify relevant content and make personalized product recommendations without requiring user input for search queries.

The system utilizes video recognition and analysis technologies to detect and understand the trending items or contexts presented in the video. These detected items are then compared with products in the database, and recommendations are generated accordingly. Based on this analysis, the system generates product recommendations that are relevant to the video content, enhancing the user experience and providing more accurate and timely product suggestions. The user interface is designed to present these recommendations in a user-friendly manner, allowing users to easily explore and act on product suggestions.

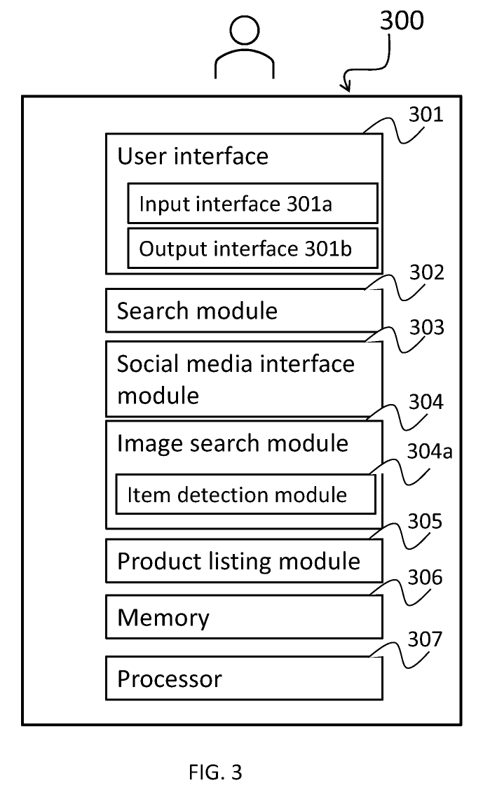

FIG. 3 is an architecture diagram of the user terminal according to an embodiment of the invention.

In accordance with an example embodiment, the user terminal 300 may include a user interface 301, a search module 302, a social media interface module 303, an image search module 304, an item detection module 304a, and a product listing module 305, one or more memories 306 and one or more processors 307.

The user interface 301 is the primary point of interaction between the user and the terminal. The user interface 301 includes both input interface 301a and output interface 301b to provide a user-friendly experience. The user interface 301 may obtain the user input, such as a search query from a user, may present a search result list to a user, may obtain item selections from a user, and may present a product listing to the user.

For the input interface 301a, the user interface 301 allows users to input the search query, enter information, make selections, and interact with the system. Common input methods include touchscreens, keyboards, voice commands, and mouse inputs. The input interface supports search queries, navigation, and user commands.

For the output interface 301b, the user interface 301 displays information and feedback to the user. The user interface 301 includes visual elements such as screens or monitors, where users can view product details, recommendations, and live streaming content. The output interface also includes audio components for notifications and alerts.

The search module 302 enables users to find products quickly and efficiently. The search module 302 processes user input to perform searches based on keywords, categories, or filters. The module is equipped with algorithms that match user queries with relevant product listings and present the results in an organized manner.

The social media interface module 303 is to integrate with various social media platforms. The social media interface module 303 may, for example, forward and analyze the search query of the user to the social media platform and determine trending products to recommend to the user corresponding to the search query provided. In some embodiments, it also allows users to share their shopping experiences, post reviews, and interact with others and recommend the products based on the social media platform. This information can be selectively applied in a number of ways, including, but not limited to, by determining whether a large volume of activity is based on positive and favorable commentary on a product, or is based on negative or scandalous commentary on a product. This module supports the integration of social media feeds, sharing buttons, and login features for platforms such as those branded TikTok, Facebook, Twitter, and Instagram.

The image search module 304 handles the analysis and manipulation of the image data. The image search module 304 supports tasks such as image enhancement, object recognition, and visual search. This module enables features like identifying items from images to recommend products based on the detected items.

In some embodiments, the image search module 304 may include an item detection module 304a. The item detection module 304a is responsible for recognizing and identifying items within images, videos or live streaming data. The image search module 304 uses advanced algorithms and machine learning techniques to detect and categorize items based on their visual characteristics. This module is crucial for features like image search and real-time product detection for images, video or live streaming.

In some embodiments, the user terminal includes a product listing module 305. The product listing module 305 searches the products in the online shopping system based on the features of the detected items and manages the presentation of product information to users. The product listing module 305 organizes and displays product listings.

In some embodiments, the user terminal includes a memory 306. The memory 306 may include one or more computer-readable storage media that may be non-transitory. The memory 306 may further include a high-speed random-access memory and a non-volatile memory, such as one or more magnetic disk storage devices or flash storage devices. In some embodiments, a non-transitory computer-readable storage medium in the memory 306 is configured to store at least one piece of program code. The at least one piece of program code being configured to be executed by the processor 307 to implement the online live streaming processing, video processing and the image processing provided in the method embodiments of the invention. Adequate memory ensures that the terminal can handle multiple tasks simultaneously, such as running the search module, processing images, and managing user interactions without lag.

In some embodiments, the user terminal includes a processor 307. The processor 307 can be implemented using various technologies and architectures designed to fulfil the described functions. It may be realized as a general-purpose processor, content addressable memory, digital signal processor, application-specific integrated circuit, field-programmable gate array, programmable logic device, discrete gate or transistor logic, discrete hardware components, or a combination thereof. Additionally, a processor can take the form of a microprocessor, controller, microcontroller, or state machine. Furthermore, the processor may be realized through a combination of computing devices, such as combining a digital signal processor with a microprocessor, utilizing multiple microprocessors, integrating one or more microprocessors with a digital signal processor core, or employing any other suitable configuration. In some embodiments, the processor 307 may further include an artificial intelligence (AI) processor. The AI processor is configured to process computing operations related to machine learning for the image processing to identify the items. A powerful processor enables the terminal to handle complex operations efficiently, such as real-time image processing, running search algorithms, and managing user inputs.

A person skilled in the art will recognize that the structure depicted in FIG. 3 is not limited to the user terminal 300. The user terminal 300 may include additional or fewer components than those illustrated, some components may be combined, or alternative component configurations may be employed. The user terminal 300 described herein is not limited to local processing capabilities and can integrate with cloud-based processing systems. This allows for the delegation of computationally intensive tasks to the cloud, enabling efficient processing and real-time updates while ensuring the user terminal 300 remains lightweight and responsive.

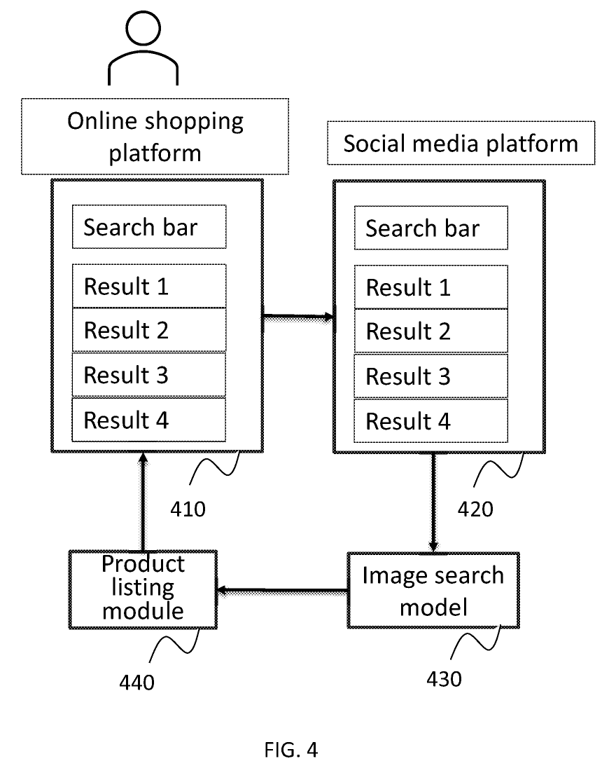

FIG. 4 is a schematic diagram of an online shopping system using a social media platform according to an embodiment of the invention.

As shown in 410, upon performing a search on the online shopping platform, users are presented with an interface displaying a list of relevant products. In some embodiments, the search results are organized in a grid or list format, showcasing product images, names, prices, and brief descriptions. Each product entry includes essential details such as ratings, availability, and any ongoing discounts.

In some embodiments, the interface has the filtering and sorting options, allowing users to refine their search based on criteria like price range, brand, or user ratings. Additionally, users can hover over or click on individual products to view more detailed information, including specifications, user reviews, and additional images.

To enhance the shopping experience, the interface often integrates with social media platform to identify the trending items in the social media platform to improve the relevance of products recommended to the users in 420.

In some embodiments, when a list of videos is identified from the social media platform, the system goes to the image search model 430 to identify items. The main goal is to detect trending items from the social media platform. In addition to video content, various other forms of social media data, such as images, live streaming, and other multimedia formats may also be analyzed to find the trending products.

In some embodiments, data from multiple social media platforms is collected and aggregated to identify trending items. By analyzing diverse sources, the system can detect emerging trends across various platforms, enhancing the accuracy and relevance of the recommendations made to users.

After identifying the items, the system sends the detected main items to the product listing module 440. The product listing module find similar products from listing based on the detected items for recommendations.

After identifying the products, the products are displayed to the users in the interface of 410.

In some embodiments, after the user watches videos on the social media platform about certain style of dresses or shoes, the user may be interested in these items. However, the user may not know how to accurately or fully describe the style. With the current invention, the user can search a general query, such as “dress” in the online shopping platform. The system would find the trending dress designs in the social media platform and recommend the products to the user. Such a system could be configured to base this determination on overall trending items on the social media platform, or trending items within a sub-population or other set of users on the social media platform, in accordance with the information available on the user submitting the query.

Overall, the online shopping system enhances the shopping experience, making it easier for users to discover products that match trending items or find more search results of interest, and ultimately drive higher engagement and sales.

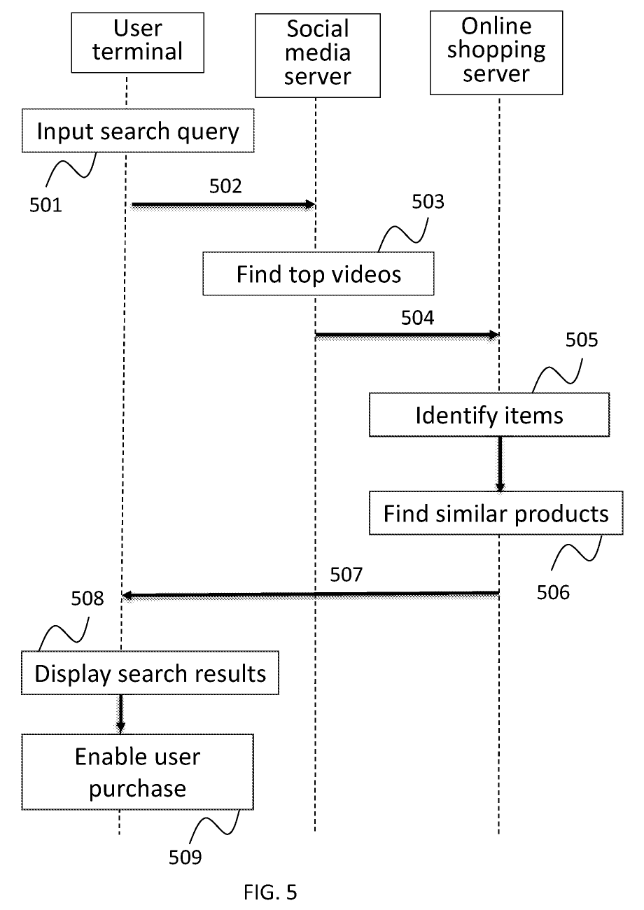

FIG. 5 is a flowchart of an online shopping system using a social media platform according to another embodiment of the invention. Using the method applied to the interaction between the terminal and the server as an example, as shown in FIG. 5, the method includes:

At step 501, the user input the search query in the user terminal. The user terminal receives the user query and processes the query to identify the user intent.

In some embodiments, the user interface includes a social media platform control, and only when a trigger operation on the social media recommendation is received, it is determined that the online shopping platform would recommend the product to the users based on the popularity of the product on the social media platform.

At step 502, the user terminal sends the query to the social media server to conduct the search in the social media platform based on the user query. The search retrieves content results, such as videos, images, or other media, relevant to the query.

At step 503, the social media server processes the search results and identifies specific content, such as the top 50 or 100 videos, based on factors like relevance or popularity..

At step 504, the social media server sends the videos to the online shopping server.

At step 505, the online shopping server performs item recognition on the videos to obtain at least one trending item using an image search model.

At step 506, upon receiving the detected item data, the online shopping server processes this information to search the online shopping product database for matching products. The server utilizes algorithms to find products that closely align with the detected items’ characteristics. For example, if a specific type of clothing is identified, the server searches for other clothing from the listing of the online shopping platform with similar features.

In some embodiments, the server stores the user preference and purchase history, so that the system can recommend more relevant products to the user based on the user preference or purchase history.

The online shopping server further ranks products in the recommended product listing, with higher-ranked items appearing at the top. This ranking prioritizes products based on relevance, popularity, and user preferences, ensuring that the most suitable and sought-after options are recommended to the user. Therefore, it can increase the possibility of the user to purchase and improve the user experience.

In some embodiments, before transmitting the product link, the server sorts the products based on various parameters, such as price index, sales volume index, and other relevant factors. This sorting ensures that the most suitable products are prioritized and presented to the user.

At step 507, the online shopping server transmits the list of recommended products to the user terminal.

At step 508, after the server transmits the list of recommended products back to the user terminal, the terminal displays a list of products in the interface. Users can interact with these recommendations, view detailed product information, and access links to purchase the recommended items.

At step 509, the user is enabled to interact with the recommended products by clicking on the purchase links. This action takes the user to the product's detail page, where they can add the item to their cart, and proceed with the purchase.

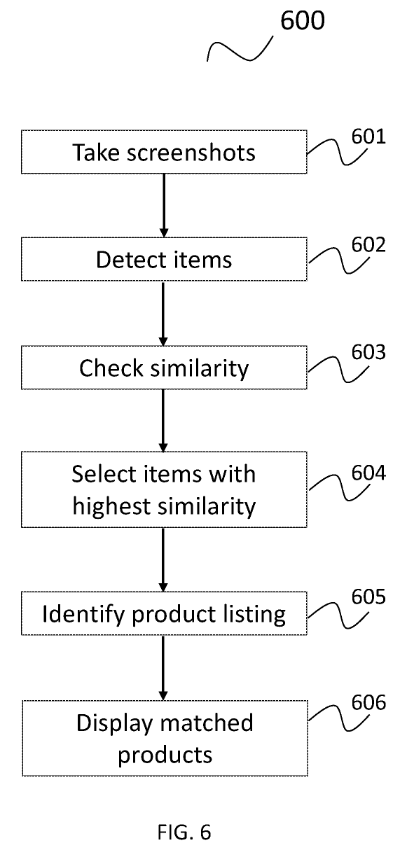

FIG. 6 is a flowchart of an online shopping system using a social media platform to detect trending products according to another embodiment of the invention.

The system retrieves videos from the social media platform based on the user query. At step 601, the system takes screenshots at different timepoints from the videos for further analysis or processing.

At step 602, the system detects items from the videos. Specifically, the system identifies the main item in the images using the image search model, which uses machine learning models to detect objects within video frames. Techniques such as convolutional neural networks (CNNs) can be employed to identify the items. For each detected item, the system also extracts features. These features might include color, shape, texture, and other visual characteristics.

At step 603, the system checks similarities among different items. The system compares the features of items that have been identified across different videos using similarity metrics such as cosine similarity, Euclidean distance, or other relevant metrics depending on the feature type. The system can group similar items together using clustering algorithms like k-means or hierarchical clustering to identify items that are visually or contextually similar across videos.

At step 604, the system selects the items with the highest similarity scores and these items are the trending items from the social media platform. In some embodiments, it also analyzes the frequency of occurrence of the selected high-similarity items across the videos. Items that appear frequently and have high similarity scores are likely to be trending. Hence, the system can combine frequency and popularity metrics to determine the overall trending items from the different videos. These are the items that are most frequently appearing and are most similar across the videos, indicating a potential trend. In some embodiments, the system also considers additional metrics such as the context in which items appear (e.g., in popular scenes or associated with popular themes) to identify trends. Hence, this method can systematically detect, compare, and identify trending items across multiple videos based on visual and contextual similarities.

At step 605, the system identifies the product listing from the online shopping system. The system attempts to match these items images uploaded by the sellers based on the image search model. In some embodiments, the system also compares detected products with the product database to retrieve detailed information, including product names, descriptions, and purchasing options.

At step 606, the system displays the matched products to the users. The method collects the matched products from a product listing as the search results. The matched products are ranked based on relevance and returned to the user.

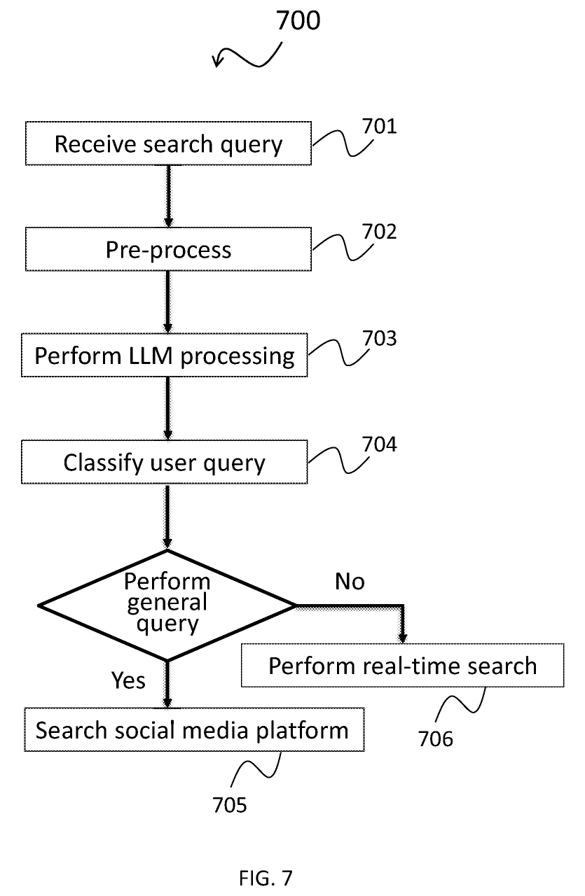

FIG. 7 is a flowchart of a method for online shopping with a social media platform to identify the general query according to an embodiment of the invention.

It is hard to find what styles, or which products users (e.g., buyers) really want when the search query is general/broad for the online shopping system. The click through rate of search results of general queries is significantly lower than specific queries.

Traditional search engines often struggle to accurately discern whether a user’s search query reflects a general interest or a specific need. Understanding user intent is crucial for delivering relevant search results. The invention provides a process for analyzing and classifying search queries to determine whether the user intent is general or specific. This classification aids in delivering more relevant search results and improving user click through rate.

FIG. 7 is a method to address the above problem. In some embodiments, the invention provides a method for classifying user search queries into general or specific intents using advanced Natural Language Processing (NLP) algorithms, such as Large Language Models (LLMs). The system processes search queries through an LLM to extract contextual and semantic meaning, which is then used to classify the intent. This classification improves the accuracy of search results and enhances the overall user experience. Only when the search query is classified as generic will the method then rely on the social media platform to improve the search results.

In some embodiments, a predefined list of general queries is maintained. If a user's query matches an entry on this list, it is classified as a general query.

At step 701, the method begins by receiving a search query from a user, which serves as the input for the subsequent processing steps.

At step 702, in some embodiments, the search query undergoes several preprocessing steps to enhance its accuracy and relevance. This includes tokenization, which breaks down the query into individual words or tokens; normalization, which standardizes the text by converting it to a consistent format; and vectorization, which transforms the text into numerical vectors that represent its semantic meaning in a form suitable for analysis.

At step 703, the preprocessed query is then analyzed using an LLM. This advanced model interprets the query by understanding its context and semantics. The LLM captures the deeper meanings and relationships within the query, facilitating a more accurate interpretation of what the user is searching for.

At step 704, based on the analysis from the LLM, the method determines whether the user's intent is general or specific. This step involves evaluating the query to discern if the user is looking for broad information or has a particular, targeted request. For example, if the search query is “dress”, it will be classified as general search query. In contrast, a specific search query could be “a yellow dress with floral patterns for Christmas party”.

At step 705, if the search query is determined to be a general query, it would forward the search query to the social media platform to find the trending items in the social media platform. Otherwise, at step 706 if the search query is determined to be a specific query, it would perform the real time search based on the specific search query without referring to the social media platform.

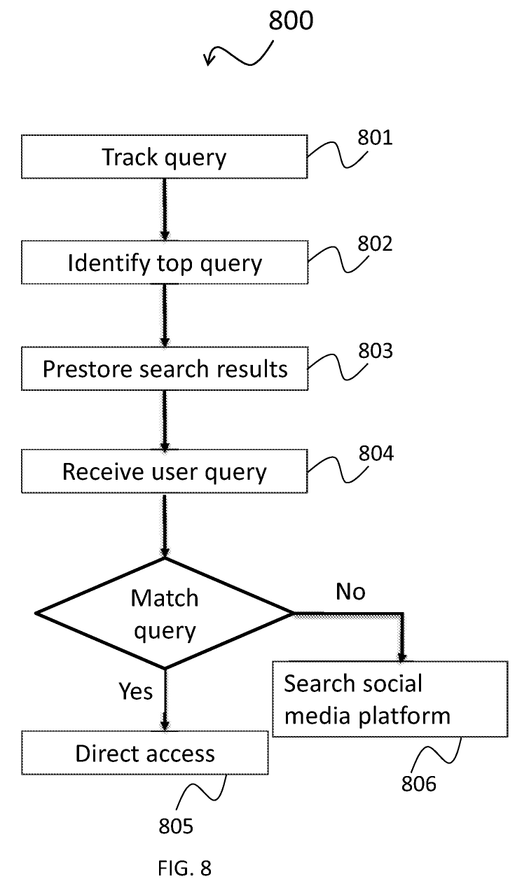

FIG. 8 is a flowchart of a method for online shopping with a social media platform with prestored trending items according to an embodiment of the invention.

In some embodiments, the invention provides a video search system that includes a presearch step to identify and cache the most frequently searched queries over a specified period, such as one week. By prestoring the results of these popular queries, the system enables users to access relevant videos quickly and efficiently without having to wait for real-time search processing. Therefore, it enhances the user experience by reducing search time.

At step 801, the method tracks search queries submitted by users over a period of time, such as one week. This involves logging each query and the frequency with which it is searched.

At step 802, at the end of the tracking period, the method analyzes the logged data to identify the top queries based on frequency. The top queries are selected for further processing.

At step 803, for each identified top query, the method performs a search and retrieves relevant content from the social media platform. The videos are processed to identify the trending items, including where appropriate by reference to metadata such as descriptions, comments, tags, or other data used by users to annotate or add information about the content. In some embodiments, the method also identifies a list of products from the online shopping system based on the trending items.

The retrieved video results, the trending items and/or the recommended products for the top queries are stored in a cache or prestorage database. This prestored data is organized for quick retrieval and optimized for performance.

At step 804, when a user inputs a new search query, it first checks if the query matches or is likely relevant to any of the prestored top queries.

At step 805, if the query matches or is likely relevant to a prestored top query, it retrieves the cached results of the trending items and recommends the list of products based on the trending items.

At step 806, if the query does not match any prestored top queries, it performs a real-time search in the social media platform and processes the query as usual.

Therefore, the present invention improves search efficiency by presearching and prestoring results for the most frequently searched queries over a given period. This system minimizes wait times for users by providing direct access to prestored results for popular queries and processing other searches in real-time.

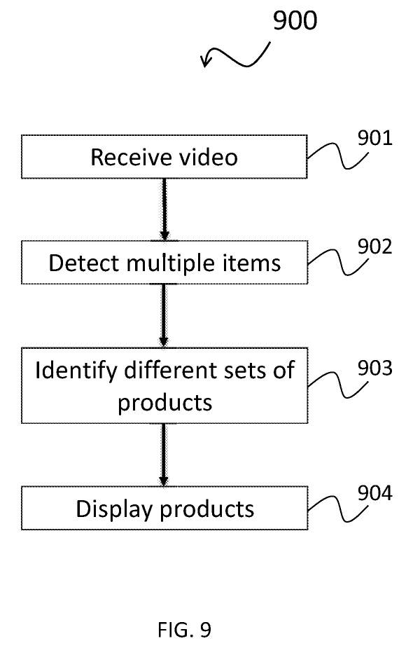

FIG. 9 is a flowchart of a method for online shopping by detecting multiple items according to an embodiment of the invention.

In some embodiments, the present invention relates to a system and method for identifying multiple trending products, recommending products based on these trends, and displaying them in a balanced and user-friendly manner.

At step 901, it receives the videos from the social media platform for a search query.

At step 902, it detects multiple trending items from the videos for a generic search query. For example, when the user input query is related to dress, the system detects three main styles of dresses that are currently trending on the social media platform.

At step 903, it identifies different sets of recommended products based on the detected trending items. For example, after detecting three main styles of the dresses, the system would identify three sets of products in the online shopping system to match with the three styles of the dresses identified in the social media platform.

At step 904, after generating different sets of products based on the multiple trending items, a combined list of the products is displayed to the users. The interface displays the recommended product listing in a balanced and proportional manner, ensuring that products from different categories are equally represented and avoiding the over representation of any single category in the user interface.

With the rise of e-commerce and social media platform, live streaming shopping has become a popular method for engaging consumers and driving sales. However, existing systems lack efficient methods for real-time product identification and recommendation during live streaming. Users often conduct manual searches for products shown in live streaming, which can lead to a suboptimal shopping experience.

In some embodiments, the recommended product is in a live streaming video for the online shopping system. Thus, the system provides a novel system and method for enhancing the live streaming shopping experience by incorporating real-time products identifications, suggestions, and purchase functionalities.

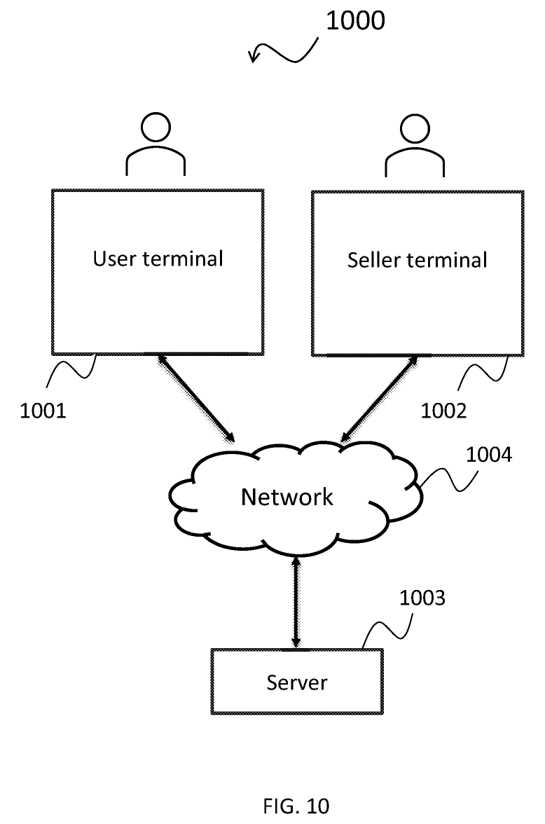

FIG. 10 is an architecture diagram of an online live streaming shopping system for an item identification according to an embodiment of the invention. As shown in FIG. 10, the online live streaming shopping system includes, but is not limited to, a user terminal 1001, a seller terminal 1002 and a server 1003. These elements within the system 1000 can be interconnected by a network 1004. The system could also comprise a social media server.

The live streaming seller logs into their account on their terminal, opens a live streaming viewer room, and begins capturing the live streaming video through a camera. The seller terminal 1002 can transmit the live streaming data to the server 1003. The user terminal 1001 can receive the live streaming data returned by the server 1003, then decode the received live streaming data to obtain an audio frame and a video frame. Therefore, the user terminal 1001 can display the live streaming, so that the user can watch a live streaming through the user terminal 1001 to conduct the further online shopping process.

This video streaming is then transmitted to the server. The server plays a critical role in encoding the audio and video frames from the live streaming and distributing the encoded live streaming data to the user’s terminal.

The user terminal 1001 and the seller terminal 1002 represent examples of the types of terminals involved. However, it is important to note that this is just one possible scenario. A person skilled in the art will recognize that the number of terminals can vary widely; there could be just one terminal, or there might be dozens, hundreds, or even more. The specifics of the quantity and types of devices used are not limited by this embodiment of the application.

It is noted that, although live streaming is used as an example in embodiments of the present invention, other types of image or video platforms capable of identifying and recommending products to users may also be utilized without departing from the scope of the invention. For instance, this includes any image or video platform that can recommend products to users.

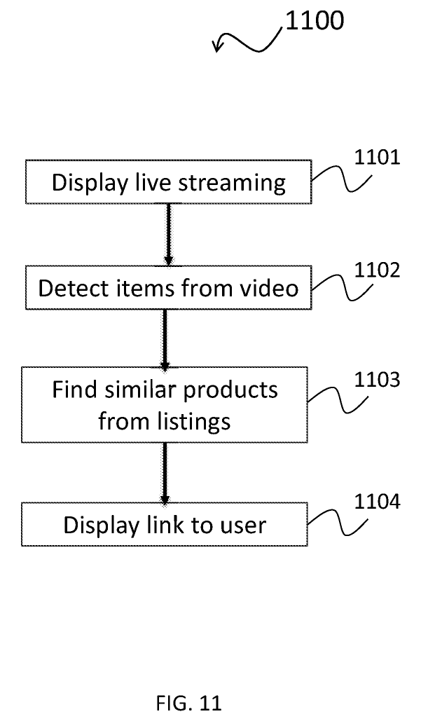

FIG. 11 is a flowchart of a method for displaying item information for the online shopping live streaming system according to an embodiment of the invention. The online shopping platform incorporates a live streaming function, allowing users to watch live streaming directly on the platform.

The current live streaming and videos only allow users to purchase specific items being sold by the content creator during the live streaming and videos. However, users may also be interested in purchasing other items featured in the video/ live streaming. The invention is expected to do a real-time detection of the products featured in the live streaming of the online shopping platform.

Referring to FIG. 11, method being performed by a terminal as an example, the method includes the following steps:

At step 1101, the live streaming data is displayed to the user. The live streaming data is selected by the user or recommended to the user based on the user search query. The method starts by displaying a live streaming that features a live streaming host in a live streaming online shopping platform. This live streaming includes at least one target item that the host is promoting. The live streaming captures not only the target item, but also other items present in the live streaming, such as accessories or related products. For example, a seller is showing and selling her dress in her live streaming room, other accessories such as earrings are also featured in the live streaming. The live streaming consists of a plurality of frames from the live streaming, which can be used for image processing to identify the items featured in the image.

In some embodiments, the live streaming is shown in a live streaming interface, which overlays display elements such as live streaming viewer room information, comment sections, and product link controls. These controls include links to products recommended by the host. The viewer can interact with these links to access detailed information and make purchases.

At step 1102, the method detects items from the live streaming. During the live streaming, the host recommends specific products, and these recommendations are highlighted in the live streaming. Viewers can select these product links to be redirected to a product purchase interface. In addition to the recommended products, viewers can use item recognition operations to identify and interact with other items displayed in the live streaming image, providing a broader shopping experience.

In some embodiments, the live streaming viewer room is a feature within the shopping platform, specifically designed for live streaming. Within this viewer room, the live streaming host can include product links that direct viewers to purchase the featured products. When a viewer clicks on one of these product links, they are taken to a product purchase interface where they can complete their transactions.

Additionally, beyond the products directly linked by the host, viewers have the option to use item recognition function to identify and interact with other items shown in the live streaming. This functionality allows user to explore and engage with additional products displayed during the live streaming, expanding their shopping experience beyond the host's recommendations.

In some embodiments, when the live streaming host recommends dressing, the live streaming image includes the clothes recommended by the live streaming host, and the live streaming further includes other items such as accessories worn by a model and decorations in a room.

At step 1103, after the items are identified, such as detection of the earrings, the method then initiates a search based on the characteristics and attributes of the identified item. The method attempts to match the detected items shown in the live streaming and the images uploaded by sellers in the online product listing of the online shopping platform. If there is any product related with high similarity score, it is identified as the target products.

In some embodiments, it extracts key attributes from the identified items, such as category, brand, features, price range, and user reviews. This information forms the basis for finding similar products. Using the extracted attributes, the system performs a comprehensive search across its product database to generate a list of items that match or complement the selected product. This includes items from the same category, products with similar features, or related accessories that might be of interest to the user.

To address the varied ways users might identify and search for products, the current invention incorporates two primary methods for product identification: text-based search and image-based search.

The first method, text-based search, relies on keywords or search strings. In this case, the system interprets the detected items and generates a search string based on the detected items. For instance, a system may generate a search string of “black silk cheongsam” based on the detected items and leverages it to retrieve relevant products. The power of this approach lies in the system’s ability to recognize specific attributes of the detected items and generate a search string based on the detected items. Moreover, this approach can incorporate trending terms and phrases sourced from the social media platform, enriching the search results with up to date, in-demand products.

The second method, image-based search, focuses on product identification through image search. Here, the system uses a method of image search to match the design of the detected items seen in an image or video with similar products. For example, after detecting the items from the video, the system can further retrieve comparable products from the platform by image search. By analyzing the design attributes in the original image, such as color, pattern, silhouette, or fabric type, the system compares these attributes with the product images available on the platform. This visual search approach is especially helpful for users who may lack the specific language to describe what they are looking for or who are inspired by visuals rather than product names. It enhances accessibility by enabling users to find items that match their visual preferences more intuitively. The products identified, whether through text-based search or image-based search, can be recognized as trending products for recommending to users.

At step 1104, a purchase link is displayed to the user, therefore the user can click the link to conduct the purchase. The recommended products are displayed to the user in a dedicated section of the shopping platform or live streaming interface. Users can view these recommendations alongside the original product, with options to explore more details or make additional purchases. When users choose a product link, they are directed to the product purchase interface. Here, they can finalize their purchases, completing the transaction.

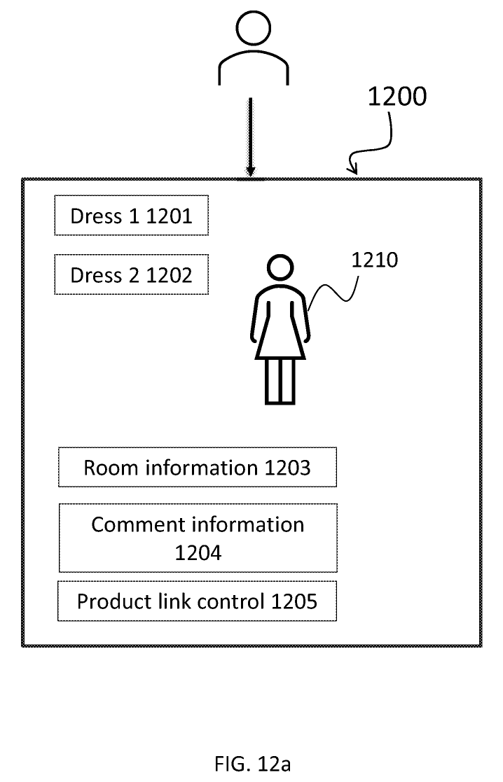

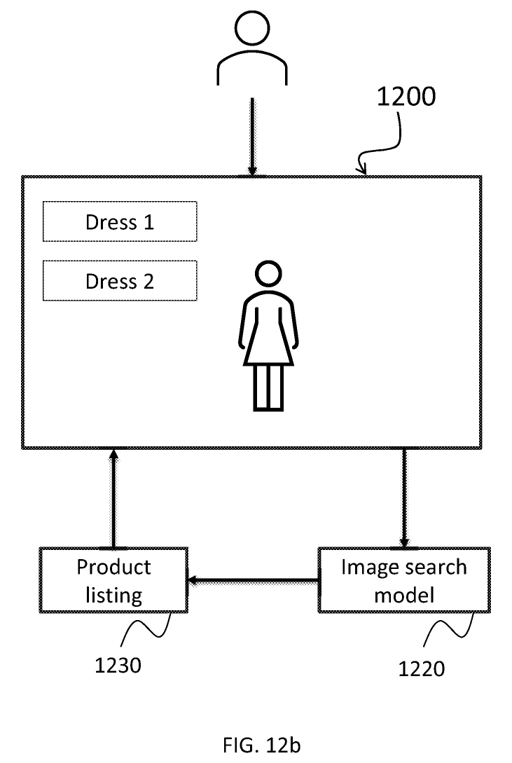

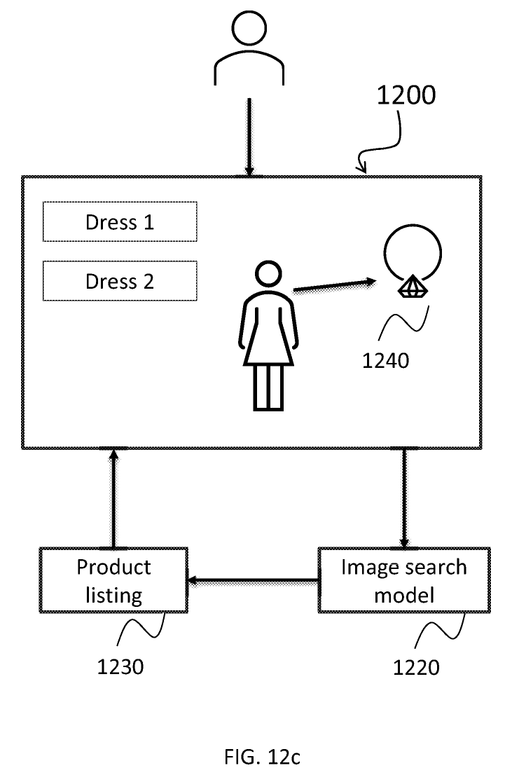

FIG. 12a is a schematic diagram of a live streaming interface according to an embodiment of the invention.

As shown in FIG. 12a, the live streaming interface 1200 features a live streaming host 1210 who is actively broadcasting. The host is selling the dressing in the live streaming room, and the live streaming environment also includes other items, such as earrings of the host or the clock on the wall. There are one or more links 1201 and 1202 displayed already for the dresses the host is selling. Hence, the user can click on the link to proceed with the purchase.

In some embodiments, the live streaming interface 1200 is designed to provide additional interactive elements commonly in the live streaming interface, including live streaming viewer room information 1203, comment information 1204, and a product link control 1205. For the live streaming viewer room information 1203, it displays details such as the name of the live streaming viewer room and the title of the live streaming. For the comment information 1204, it shows public comments made by user within the live streaming viewer room. For the product link control 1205, it is used to manage the product links for items recommended by the live streaming host. By interacting with the product link control 1205, the user can decide whether to trigger the operation of identifying new items for recommendation. If triggered, the system will provide new product links for consideration. Otherwise, the identification process will not be initiated, and no new recommendations will be generated. This setup ensures that viewers not only enjoy the live streaming content but also have access to interactive features that enhance their viewing experience and facilitate product discovery.

FIG. 12b is a schematic diagram of a live streaming interface to identify items in the image according to an embodiment of the invention.

As shown in FIG. 12b, a live streaming interface has a real time detection function to detect items in the live streaming. This function can be controlled by the system to turn on if the online shopping system finds items from the listing by interacting with the product link control 1205 in FIG. 12a. This function is turned off by default. In some embodiments, this function can be turned on by the users. When a trigger operation on the item recognition control is received, the system goes to the image search model to identify the items. The main goal is to detect main items on the screenshots from the live streaming.

After identifying the items, it sends the detected main items to the product listing module 1230. The product listing module 1230 finds similar products from listing based on the detected items for recommendations. The product link is also generated to be displayed in the live streaming room.

FIG. 12c is a schematic diagram of a live streaming interface with identified products according to an embodiment of the invention.

As shown in FIG. 12c, after detecting the recommended product, a product link of earrings is displayed in a live streaming interface 1200. The user can interact with the product link 1240 to purchase the product.

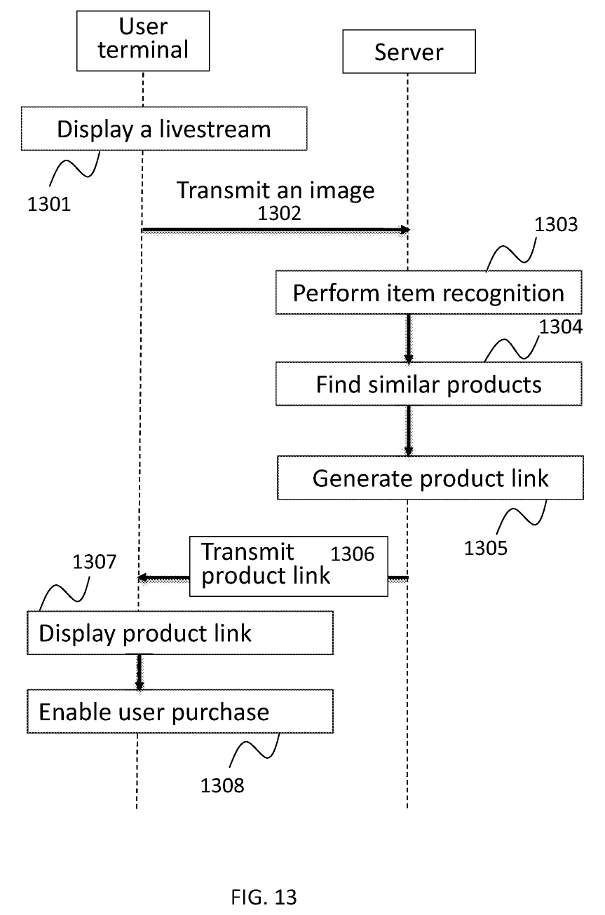

FIG. 13 is a flowchart of a method for item identification according to another embodiment of the invention. Using the method applied to the interaction between the user terminal and the server as an example, as shown in FIG. 13, the method includes:

At step 1301, the user terminal displays a live streaming, and the live streaming includes a live streaming host performing in a live streaming environment and at least one item located in the live streaming environment.

The user terminal receives the live stream from the server. This live streaming is continuously displayed to the viewer, allowing them to watch the live streaming host and view the items featured in the environment.

In some embodiments, the live streaming interface includes an item recognition control, and when a trigger operation on the item recognition control is received, it is determined that the terminal receives the item recognition operation. The item recognition operation is configured to perform recognition on the at least one item in the live stream image.

At step 1302, in response to the item recognition operation, the user terminal obtains the live streaming by taking screen shot of the live streaming and transmit the image to the server.

The terminal transmits an item recognition request to the server, the item recognition request being configured to indicate to perform item recognition on the live stream.

In some embodiments, the item recognition request carries the timestamp corresponding to the live stream that needs to be recognized, so that the server can obtain, based on the timestamp, the live streaming from cached live stream data.

The item recognition request further carries a user information, and the server stores the user preference and purchase history, so that when the system can recommend more relevant products to the user based on the user preference or purchase history.

At step 1303, the server receives the images of the live streaming and performs item recognition on the live streaming to obtain at least one item included in the live stream. The object detection module classifies the detected items based on predefined categories and attributes. Each identified object is analyzed to determine its type, and other relevant features.

At step 1304, upon receiving the detected item data, the server processes this information to search the online shopping product database for matching products. The server utilizes algorithms to find products that closely align with the detected items’ characteristics. For example, if a specific type of earring is identified, the server searches for other earring from the listing with similar features.

At step 1305, the server generates at least one product link to recommend to the user.

The server generates a list of recommended products based on the object detection results. This list includes items similar to or complementary to the detected objects in the live stream. The recommendations are tailored to match the viewer’s interest, and the products featured by the live stream host.

At step 1306, the server transmits at least one product link to the terminal.

The server transmits the list of recommended products back to the user terminal. This information is integrated into the live streaming interface, allowing the viewer to see product recommendations alongside the live streaming.

At step 1307, the terminal, based on a display region of an item in the live streaming, displays a product link.

The user terminal displays the recommended products within the live streaming interface. Viewers can interact with these recommendations, view detailed product information, and access links to purchase the recommended items.

At step 1308, the user can interact with the recommended products by clicking on the purchase links. This action takes the user to the product's details page, where they can review additional information, add the item to their cart, and proceed with the purchase.

The viewer can select recommended products to view more details or make purchases directly through the application. In some embodiments, the terminal receives a click operation on the product link. The user terminal facilitates these interactions, ensuring that the shopping experience is seamless and integrated with the live streaming.

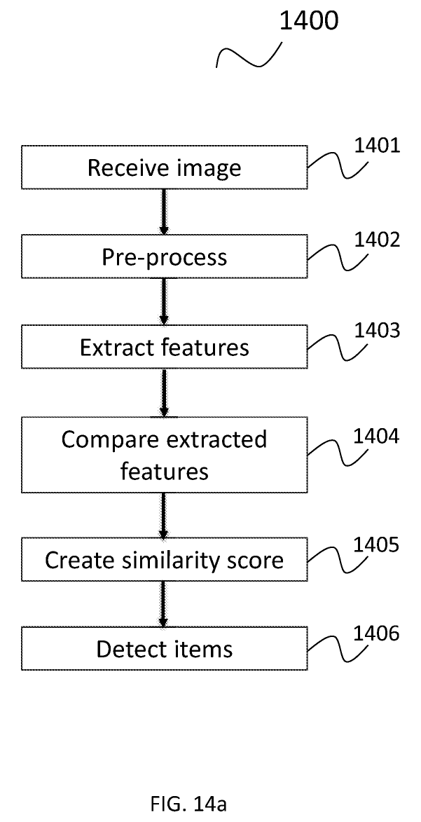

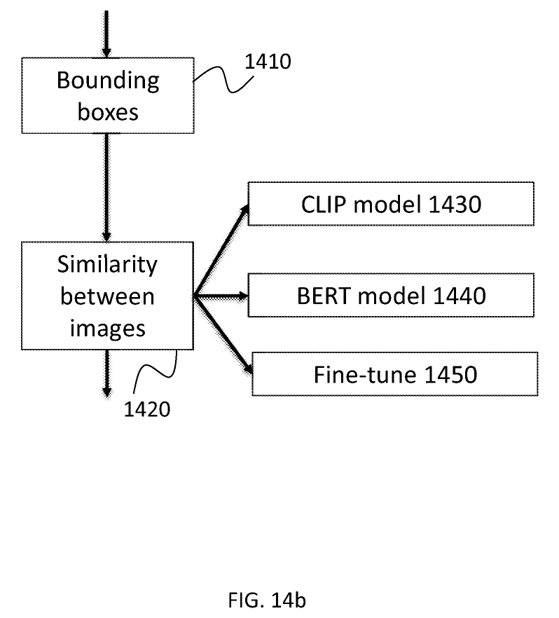

FIG. 14a is a flowchart of a method of image processing for detecting items according to an embodiment of the invention.

When the method performs item recognition on the image by either the user terminal or the server to obtain at least one item in the image, the process can be roughly divided into the following steps: receiving the image, preprocessing, feature extraction and selection, comparing the extracted feature, calculating the similarity score and item detection decision-making.

At step 1401, it receives the image. In some embodiments, it captures and processes the live streaming feed in real-time. The livestream feed processor captures and processes the video feed from live streaming. This component continuously receives video data, which is then converted into individual frames for further analysis. The processor ensures that the video feed is processed in real-time, maintaining synchronization with the live broadcast.

At step 1402, the preprocessing steps are applied to the image. The method performs initial data extraction from the image or video feed, including frame extraction and basic quality enhancement. This step prepares the image or video frames for detailed analysis by subsequent components.

In some embodiments, the pre-processing mainly refers to operations of denoising, smoothing, and transformation in image processing, to improve their quality and consistency. Tasks include normalization to adjust brightness and contrast, augmentation to enhance frame features, and denoising to reduce visual noise. Preprocessing ensures that the subsequent feature extraction process operates on high-quality data.

At step 1403, the method extracts features from the images. Feature extraction involves capturing and quantifying various attributes that describe the objects. The method employs advanced image processing techniques and machine learning algorithms to extract the features. In some embodiments, it utilizes CNNs to extract visual features from the images. CNNs are particularly effective in detecting and classifying patterns in images due to their hierarchical structure, which captures spatial and temporal features. The CNNs are trained on extensive datasets of product images, enabling them to recognize a wide range of products.

In some embodiments, the key features may include attributes such as shape, color, texture, and other deep features. Shape features can be extracted using techniques like edge detection (e.g., Canny Edge Detector) and contour analysis, while geometric properties can be quantified using descriptors such as Hu Moments or Shape Context. Color features can be extracted using techniques like color histograms (e.g., RGB histograms) or color moments to capture the color attributes of objects. Texture features describe the surface patterns of objects. Techniques such as Gray-Level Co-occurrence Matrix (GLCM) and Local Binary Patterns (LBP) are used to quantify texture properties.

At step 1404, the method compares the extracted features. After feature extraction, it compares the extracted features with a database of items images and descriptions. This comparison is performed using similarity metrics and scoring algorithms, which evaluate how closely the features match known products. The unit identifies the best match based on these scores, allowing for accurate item recognition.

Various metrics and algorithms are used to measure similarity. In some embodiments, Euclidean Distance is used to measure the straight-line distance between feature vectors. In some embodiments, Cosine Similarity is used to measure the cosine of the angle between feature vectors to determine how aligned they are. This calculation of the cosine of the angle between two vectors and determines whether two vectors are pointing in roughly the same direction. In some embodiments, Structural Similarity Index (SSIM) is used. SSIM measures the similarity between two images based on luminance, contrast, and structure terms.

At step 1405, the similarity score is calculated. A similarity score is computed to quantify how closely the items in the input image match those in the reference image. Higher scores indicate greater similarity. These scores can be used to rank or categorize detected items.

At step 1406, one or more items are detected. In some embodiments, the system evaluates each item by comparing its similarity score against a predefined threshold. If the similarity score exceeds this threshold, the system confirms the detection of the item and provides the results accordingly. Conversely, if the score falls below the threshold, the item is not detected, and no results are generated. In certain cases, when the similarity score is lower than the threshold, the system may issue a notice indicating that the item could not be confidently identified. This approach ensures that only items with a high degree of similarity are detected.

FIG. 14b is a flowchart of a method of image processing for detecting items according to another embodiment of the invention.

The image processing step can be divided into two stages. For stage 1, the bounding box is determined for each of the items. For stage 2, different image processing algorithms are used to determine the similarity between the images to identify items.

At stage 1, this step involves detecting objects within the image using bounding boxes at step 1410. Bounding boxes are rectangular boxes that are drawn around each detected object to define its location and extent. To achieve this, various image processing algorithms and techniques are employed, including:

In some embodiments, advanced machine learning algorithms are employed to identify the bounding boxes. For instance, algorithms such as YOLO (You Only Look Once), CNNs, Faster R-CNN (Region-based Convolutional Neural Network), or SSD (Single Shot MultiBox Detector) are utilized to detect and localize objects by predicting bounding boxes.

These algorithms often use pre-trained models that have been trained on large datasets like COCO (Common Objects in Context) or ImageNet. These models can identify a wide range of objects and provide bounding boxes around them.

In some embodiments, after bounding boxes are initially detected, post-processing techniques such as Non-Maximum Suppression (NMS) are applied to eliminate redundant boxes and retain the most accurate ones.

At stage 2, it uses different algorithms to determine similarity between images at step 1420 to identify the items.

In some embodiments, a Contrastive Language–Image Pre-training (CLIP) model 1430 is used for the image processing to identify the items.

The CLIP model learns to understand images and text by training on a large dataset of image-text pairs. The model aligns visual and textual information in a shared embedding space, enabling it to perform various tasks, including object detection, by leveraging both image and textual descriptions.

The detailed steps are as follows:

The input image is processed by the CLIP model’s image encoder to obtain a feature vector. This vector captures the visual information of the image in a high-dimensional space. When an image is analyzed, its key features are first extracted, which may include characteristics such as color, shape, texture, and spatial layout. These features are then processed through an image embedding model, which converts each feature into a high-dimensional vector representation, known as a feature vector.

Once the feature vectors for an image are generated, they are compared with the embedded feature vectors of a reference image. The comparison is based on mathematical similarity metrics, such as cosine similarity or Euclidean distance, which measure the closeness of the vector representations. If the similarity score between the embedded feature vectors of the image and the reference image exceeds a predetermined threshold, the system identifies one or more items in the image as matching the reference.

This embedding-based comparison allows for robust identification of items, even when there are variations in scale, orientation, or lighting conditions in the input image. By converting the image features into high-dimensional vector space, the system can perform more accurate and efficient item detection.

In some embodiments, Vision Transformers (ViTs) models are used for the CLIP model. ViTs apply transformer architecture, typically used in NLP tasks, to image processing. Unlike CNNs that rely on hierarchical feature extraction, ViTs treat image patches as sequences and process them similarly to how words are processed in NLP. This approach leverages self-attention mechanisms to capture long-range dependencies and contextual information within an image. The ViTs models divide an image into fixed-size patches, correctly embeds each of them, and includes positional embedding as an input to the transformer encoder.

In some embodiments, a BERT model 1440 is combined with the CLIP model 1430 to enhance object detection by leveraging advanced text processing and image understanding.

The BERT model’s bidirectional encoding captures nuanced meanings and context of words, leading to more accurate similarity assessments between image content and textual descriptions. The BERT model processes the text prompts to generate embeddings that capture the context of each description. Textual descriptions or prompts related to the objects are preprocessed and tokenized. The BERT model encodes these tokenized texts into dense embeddings. The BERT model’s bidirectional approach allows it to understand the context of each word in relation to other words in the prompt, enhancing the semantic understanding of the descriptions. The BERT model’s encoded textual descriptions are mapped into the same feature space as the image embeddings using the CLIP model’s text encoder.

By integrating the BERT model, the object detection system can better understand complex textual descriptions, leading to improved classification of objects within bounding boxes.

In some embodiments, to adapt the CLIP model to specific object detection tasks, a fine-tuning step 1450 is performed to improve its performance on specialized datasets or to focus on particular object categories. This involves adjusting the weights of the pre-trained model to better fit the new data while retaining the general knowledge acquired during the initial training. Fine-tuning can improve detection accuracy for specialized tasks.

Therefore, using the CLIP model for object detection combines powerful visual and textual understanding to achieve accurate and flexible detection capabilities. By leveraging its ability to align image and text representations, the CLIP model enables sophisticated object detection processes that can handle a wide variety of objects and descriptions with minimal need for task-specific training.

The use of sophisticated image processing algorithms ensures high accuracy in item recognition, improving the reliability of product information and enhancing user satisfaction.

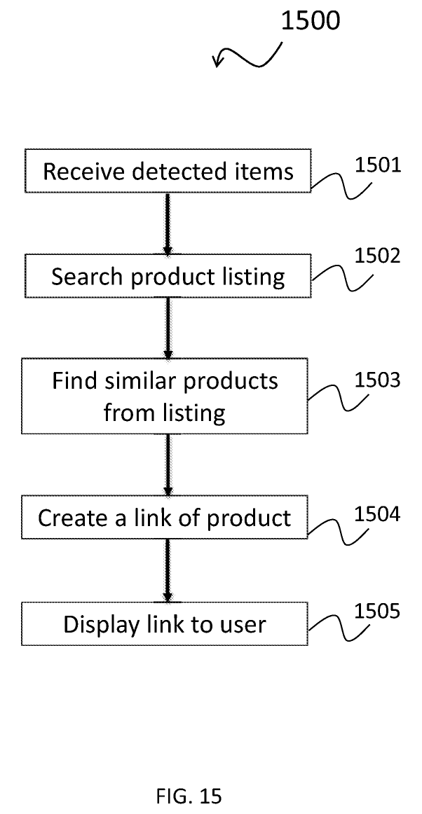

FIG. 15 is a flowchart of a method for displaying recommended products for the online shopping system according to an embodiment of the invention.

At step 1501, it receives the output of the detected items from the image processing step.

At step 1502, it searches the product listing of the online shopping platform based on the detected items. The online shopping platform has a pool of products for sale.

The system extracts key attributes from the detected items. These attributes may include product category, brand, color, size, material, and any other relevant features. The attributes provide the basis for finding similar products.

In some embodiments, the system constructs a search query using the extracted attributes. This query is designed to find products that match or are similar to the selected item. The search query may include keywords, filters, and other parameters derived from the item's attributes. The search query is sent to the product database, where it is used to search for products that fit the criteria. The database includes a wide range of products, and the search process identifies products that closely align with the attributes of the selected item.

At step 1503, the method identifies the similar products. The method identifies a list of similar products based on the search results. This list includes products that match the selected item's attributes or belong to the same category. The method may rank these products based on relevance, popularity, and/or user preferences. The method then generates product recommendations for the user.

In some embodiments, this approach recommends products based on their attributes and the user’s past interactions with similar items. The system analyzes product features and user preferences to provide suggestions that align with the user’s known interests.

In some embodiments, it calculates relevance scores for recommended products based on factors such as user preferences, browsing history, and current trends. These scores help rank and present the most relevant recommendations to users. The products with the highest scores are recommended to the user.

At step 1504, for each recommended product, the method generates a purchase link. This link directs the user to the product's details page, where they can view more information and complete the purchase. The link is typically created using the product's unique identifier within the database.

At step 1505, the recommendations, along with their corresponding purchase links, are displayed to the user.

Therefore, for the current invention, by providing real-time item recognition, users can obtain immediate information about products they see, creating a more engaging and interactive shopping experience. Users can easily identify and access product details without manually searching for items, streamlining the shopping process and potentially increasing conversion rates.

By addressing the need for enhanced interactivity and efficiency in online shopping, the present invention provides a novel and valuable solution to both users and retailers in the digital marketplace.

For the current invention, any suitable programming language can be used to implement the routines of particular embodiments such as C, C++, Java, and assembly language. Different programming techniques can be employed such as procedural or object oriented. The routines can execute on a single processing device or multiple processors.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform which is described in particular embodiments.

While various aspects and embodiments have been disclosed herein, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims. The various aspects and embodiments disclosed herein are for purposes of illustration and are not intended to be limiting, with the true scope and spirit of the invention being indicated by the appended claims.

What is claimed is:

1. A method of providing recommendations, comprising:
receiving a query at a first platform from a user;
conducting a trend analysis based on the query;
generating one or more recommendations based on results of the trend analysis; and
providing the one or more recommendations to the user via the first platform.

2. The method of claim 1, wherein the query comprises textual input by the user.

3. The method of claim 1, further comprising:
analyzing the query;
classifying an intent of the query as either a general query or a specific query based on the analysis; and
in response to determining that the query is a general query, forwarding the query to a second platform to find trending items in the second platform.

4. The method of claim 1, wherein conducting a trend analysis based on the query further comprises:
sending the query to a second platform;
retrieving a plurality of videos from the second platform based on the query;
identifying at least one trending item from the plurality of videos; and
generating a plurality of products from the first platform by matching with the at least one trending item identified in the plurality of videos, wherein the one or more recommendations comprise the plurality of products.

5. The method of claim 4, further comprising:
taking screenshots at different timepoints of the plurality of videos;
identifying one or more items in the screenshots using an image search model;
determining similarity between the identified one or more items;
selecting one or more items with the highest similarity scores as the at least one trending item from the second platform;
matching products of the first platform with the at least one trending item from the second platform; and
determining the one or more recommendations based on the matched products of the first platform.

6. The method of claim 1, further comprising:
tracking queries submitted by users over a predetermined period;
identifying a plurality of search queries based on frequency of submission during the predetermined period;
performing searches and retrieving video results for the identified search queries in a second platform;
identifying trending items from the retrieved videos; and
prestoring the plurality of search queries and the identified trending items.

7. The method of claim 6, further comprising:
receiving the query from the user; and
determining whether there is a match between the query and the plurality of search queries;
accessing the prestored trending items of the corresponding plurality of queries in response to determining the match; and
processing the query in real-time to identify trending items in response to determining that there is no match.

8. The method of claim 1, further comprising:
identifying multiple trending items related to the query based on the trend analysis; and
displaying the one or more recommendations based on the identified trending items in a balanced manner on the first platform.

9. The method of claim 1, wherein the query comprises the user interacting with video content.

10. The method of claim 9, wherein the method further comprises:
receiving at least one video frame from the video content;
identifying one or more items using an image search model by processing the at least one video frame;
matching the one or more items to identify one or more products from the first platform;
creating a link for each of the one or more products; and
displaying the link to the user through a user interface within the video content.

11. The method of claim 10, wherein matching the one or more items further comprises using image searches to match the one or more items to a product pool in the first platform.

12. The method of claim 10, wherein identifying one or more items further comprises creating a search string based on the identified one or more items.

13. The method of claim 12, wherein matching the one or more items further comprises using the search string to search in the first platform.

14. The method of claim 10, wherein the identified one or more products is different from a product currently promoted in the video content.

15. The method of claim 10, wherein identifying one or more items using an image search model further comprises:
receiving an image derived from the video content which comprises one or more objects;
identifying one or more bounding boxes around each of the one or more objects in the image using an object detection algorithm;
extracting features from each of the one or more objects within the identified bounding boxes;
comparing the extracted features from the image with a reference image to determine similarity;
generating a similarity score that quantifies a degree of the similarity between each of the one or more objects in the image and the reference image; and
determining if the similarity score of the one or more objects is above a threshold value.

16. The method of claim 15, wherein identifying one or more objects further comprises:
embedding the extracted features into feature vectors using an image embedding model, wherein the image embedding model converts each of the extracted features into a high-dimensional vector representation; and
comparing the feature vectors of the image and the reference image to identify the one or more objects.

17. The method of claim 16, further comprising fine-tuning the image embedding model using a transformer-based model configured to capture contextual relationships between extracted features.

18. A system for providing recommendations, the system comprising:
a processor;
a memory in electronic communication with the processor; and
instructions stored in the memory and executable by the processor to cause the system to:
receive a query at a first platform from a user;
conduct a trend analysis based on the query;
generate one or more recommendations based on results of the trend analysis; and
provide the one or more recommendations to the user via the first platform.

19. A non-transitory computer-readable medium, comprising instructions that when executed by one or more processors cause the one or more processors to perform operations comprising:
receive a query at a first platform from a user;
conduct a trend analysis based on the query;
generate one or more recommendations based on results of the trend analysis; and
provide the one or more recommendations to the user via the first platform.
